(19) United States
(12) Patent Application Publication
(10) Pub. No.: US 2025/0251313 A1
(43) Pub. Date: Aug. 7, 2025

(54) SYSTEM AND METHOD FOR DETECTING ABNORMAL FEATURE IN ROTATING MACHINE

(71) Applicant: HARBOR TECHNOLOGY SOLUTIONS CO., LTD., Taipei City (TW)

(72) Inventors: Hung-Yi LU, Taipei City (TW); JR Wei TSAI, Taipei City (TW); Yu-Li Kao, Taipei City (TW)

(21) Appl. No.: 19/021,071

(22) Filed: Jan. 14, 2025

Related U.S. Application Data
(60) Provisional application No. 63/548,896, filed on Feb. 2, 2024.

(30) Foreign Application Priority Data
May 29, 2024 (TW) 113119867

(51) Int. Cl. G01M 99/00

(52) U.S. Cl. CPC G01M 99/005

(57) ABSTRACT

A system for detecting an abnormal feature of a rotating machine and a method thereof are provided. The system includes: a sensing module configured for obtaining vibration data of an accessory of a rotating machine; a data processing module configured for processing the vibration data to generate a plurality of vibration timing data; a conversion module configured for converting each of the plurality of vibration timing data into a plurality of conversion data; and an abnormal feature detection module configured for comparing a feature value distribution in the plurality of conversion data to define the accessory corresponding to the conversion data in which the feature value distribution changes as abnormal.

### CROSS-REFERENCE TO RELATED APPLICATION

This application claims the benefit of U.S. Provisional Application Ser. No. 63/548,896 filed on Feb. 2, 2024, and the benefit of Taiwan Patent Application Serial No. 113119867 filed on May 29, 2024. The entirety of each application is incorporated herein by reference.

### BACKGROUND

### Technical Field of the Invention

The present disclosure relates to a system for detecting an abnormal feature and a method thereof, and more particularly, to a system for detecting an abnormal feature of a rotating machine and a method thereof.

### Description of Related Art

After a certain period of operation, the accessories (for example, gears, chains/belts, saw belts, drill bits, and tires) used in a rotating machine (for example, power transmission equipment, conveyor belt equipment, electric saw equipment, electric drill equipment, and transportation equipment) often get damaged, which affects the overall operation of the rotating machine. Therefore, relevant technologies for detecting accessory damage have been developed. Currently, most existing technologies directly convert the detected vibration data of the accessories into frequency for analysis. However, the frequency analysis method cannot be effectively applied to the different operating speeds of rotating machines, because different operating speeds result in different frequencies, and there is no consistent comparison standard. Furthermore, in electric saw equipment, in order to avoid resonance during operation, the spacing between multiple saw teeth on the saw belt must be set to an uneven distribution, which makes it difficult to infer the position of the damaged saw teeth based on the frequency.

### SUMMARY OF THE INVENTION

The present disclosure provides a rotating machine abnormal feature detection system, which comprises: a sensing module configured for obtaining vibration data of an accessory of a rotating machine; a data processing module configured for processing the vibration data to generate a plurality of vibration timing data; a conversion module configured for converting each of the plurality of vibration timing data into a plurality of conversion data; and an abnormal feature detection module configured for comparing a feature value distribution in the plurality of conversion data to define the accessory corresponding to the conversion data in which the feature value distribution changes as abnormal.

The present disclosure further provides a rotating machine abnormal feature detection method, which comprises: obtaining, via a sensing module, vibration data of an accessory of a rotating machine; processing, via a data processing module, the vibration data to generate a plurality of vibration timing data; converting, via a conversion module, each of the plurality of vibration timing data into a plurality of conversion data; and comparing, via an abnormal feature detection module, a feature value distribution in the plurality of conversion data to define the accessory corresponding to the conversion data in which the feature value distribution changes as abnormal.

In the aforementioned rotating machine abnormal feature detection system and method, the abnormal feature detection module sequentially compares whether the feature value distribution of the same spacing interval in any two adjacent ones of the plurality of conversion data has changed, or first defines a plurality of conversion data groups by dividing the plurality of conversion data in groups of N, and then sequentially compares whether the feature value distribution of the same spacing interval in any two adjacent ones of the plurality of conversion data groups has changed, wherein N is a natural number.

In the aforementioned rotating machine abnormal feature detection system and method, the feature value distribution changes as a plurality of third quartiles corresponding to the same spacing interval in the plurality of conversion data or the plurality of conversion data groups are different from each other.

In the aforementioned rotating machine abnormal feature detection system and method, the plurality of conversion data between the plurality of conversion data groups partially overlaps with each other or do not overlap at all.

In the aforementioned rotating machine abnormal feature detection system and method, the abnormal feature detection module defines the accessory as abnormal when the plurality of third quartiles has the greatest difference between each other.

In the aforementioned rotating machine abnormal feature detection system and method, the feature value distribution is a signal-to-noise ratio value distribution, and the third quartile is calculated from a plurality of signal-to-noise ratio values in the spacing interval.

In the aforementioned rotating machine abnormal feature detection system and method, the data processing module first calculates a standard deviation of the vibration data, defines a portion of the vibration data that is greater than the standard deviation as an operation interval, and defines a portion of the vibration data that is less than the standard deviation as a standby interval, and wherein the vibration data corresponding to the operation interval between two adjacent standby intervals is the vibration timing data.

In the aforementioned rotating machine abnormal feature detection system and method, the conversion module first converts each of the plurality of vibration timing data into a plurality of intermediate data, and then converts the plurality of intermediate data into the plurality of conversion data.

In the aforementioned rotating machine abnormal feature detection system and method, the conversion module uses a first algorithm to convert each of the plurality of vibration timing data into the plurality of intermediate data, and an X-axis of the intermediate data is frequency, and a Y-axis is signal-to-noise ratio value, and wherein the signal-to-noise ratio value is a vibration amount of the vibration timing data divided by the standard deviation.

In the aforementioned rotating machine abnormal feature detection system and method, the first algorithm is Fourier transform, fast Fourier transform, wavelet transform, or empirical mode decomposition.

In the aforementioned rotating machine abnormal feature detection system and method, the conversion module uses a second algorithm to convert the plurality of intermediate data into the plurality of conversion data, and an X-axis of the conversion data is spacing and a Y-axis is signal-to-noise ratio value.

In the aforementioned rotating machine abnormal feature detection system and method, a formula of the second algorithm is d=v/f, wherein d is spacing, v is operating speed of the rotating machine, and f is frequency.

In the aforementioned rotating machine abnormal feature detection system and method, the vibration data is mechanical motion vibration data or sound vibration data.

To sum up, in the rotating machine abnormal feature detection system and method of the present disclosure, since the conversion data uses the spacing as the X-axis instead of the frequency as the X-axis, the following scenarios can be used to effectively identify abnormalities in accessories: (1) different operating speeds of rotating machine; (2) in order to avoid resonance during operation, the spacing between the plurality of saw teeth on the saw belt is set into uneven distribution.

### BRIEF DESCRIPTION OF THE DRAWINGS

FIG. 1 is a system architecture diagram of a rotating machine abnormal feature detection system according to the present disclosure.

FIG. 2 is a flowchart of a rotating machine abnormal feature detection method according to the present disclosure.

FIG. 3 is a schematic diagram of vibration data according to the present disclosure.

FIG. 4 is a schematic diagram of vibration timing data according to the present disclosure.

FIG. 5 is a schematic diagram of intermediate data according to the present disclosure.

FIG. 6 is a schematic diagram of conversion data according to the present disclosure.

FIG. 7 is schematic diagrams of a plurality of conversion data in a series according to the present disclosure.

FIG. 8 is a schematic diagram showing a change in a feature value distribution according to the present disclosure.

### DETAILED DESCRIPTION

The following describes the implementation of the present disclosure with examples. Those skilled in the art can easily understand other advantages and effects of the present disclosure from the contents disclosed in this specification, and can also implement or apply the present disclosure through other different specific embodiments.

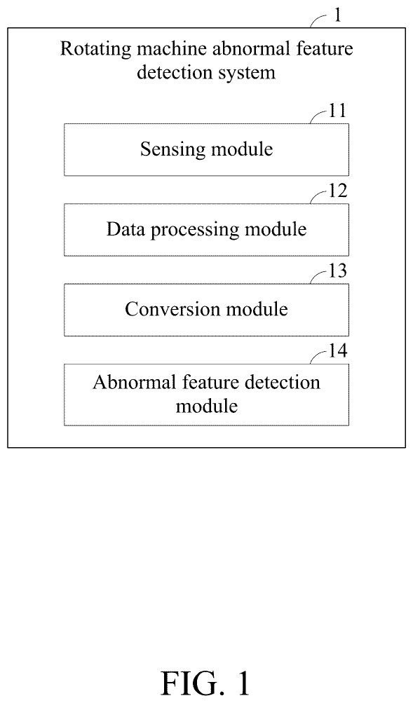

FIG. 1 is a system architecture diagram of a rotating machine abnormal feature detection system 1 of the present disclosure, wherein the rotating machine abnormal feature detection system 1 includes a sensing module 11, a data processing module 12, a conversion module 13 and an abnormal feature detection module 14.

In one embodiment, the rotating machine abnormal feature detection system 1 can be operated in a computer device having a processing unit and a storage unit. The processing unit can be a central processing unit (CPU), a microprocessor, a graphics processing unit (GPU), or an application specific integrated circuit (ASIC). The storage unit can be any type of fixed or removable random access memory (RAM), read-only memory (ROM), flash memory, hard disk, soft disk, database, or a combination of the above components of similar components. The computer device can be a mobile phone, a tablet computer, a laptop computer, a desktop computer, a server, or a cloud server.

The data processing module 12, the conversion module 13 and the abnormal feature detection module 14 can be respectively stored in the program code fragments, software, or firmware of a storage unit and can be executed by a processing unit, but the present disclosure is not limited to as such. The data processing module 12, the conversion module 13 and the abnormal feature detection module 14 can also be implemented using other hardware or a combination of hardware and software.

The sensing module 11 is used to obtain vibration data of the accessories of the rotating machine. In one embodiment, the sensing module 11 is specifically a sensor made of piezoelectric material (crystal or ceramic), or a general vibration sensor, but the present disclosure is not limited to as such. The vibration data is sound vibration data when the sensing module 11 is a sensor made of piezoelectric material, and the vibration data is mechanical motion vibration data when the sensing module 11 is a general vibration sensor.

In one embodiment, the rotating machine may be, for example, an electric saw equipment with a saw bed, and the corresponding accessory is a saw belt. In other embodiments, the rotating machine may also be, for example, a power transmission equipment, a conveyor belt equipment, an electric drill equipment, or a transportation equipment, and the corresponding accessories are gears, chains/belts, drill bits, and tires, but the present disclosure is not limited to as such.

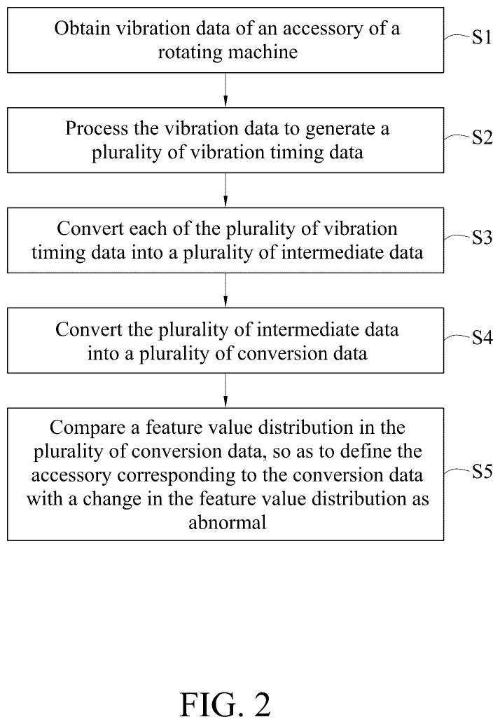

Please refer to FIG. 2. A rotating machine abnormal feature detection method of the present disclosure can be executed by the aforementioned rotating machine abnormal feature detection system 1, wherein the rotating machine abnormal feature detection method comprises: in step S1, obtaining vibration data of an accessory of a rotating machine; in step S2, processing the vibration data to generate a plurality of vibration timing data; in step S3, converting each of the plurality of vibration timing data into a plurality of intermediate data; in step S4, converting the plurality of intermediate data into a plurality of conversion data; in step S5, comparing a feature value distribution in the plurality of conversion data, so as to define the accessory corresponding to the conversion data with a change in the feature value distribution as abnormal.

The detailed operation contents of the rotating machine abnormal feature detection system 1 are further described below in the order of the rotating machine abnormal feature detection method. The technical contents of the above-mentioned rotating machine abnormal feature detection method and the rotating machine abnormal feature detection system 1 that are the same will not be repeated.

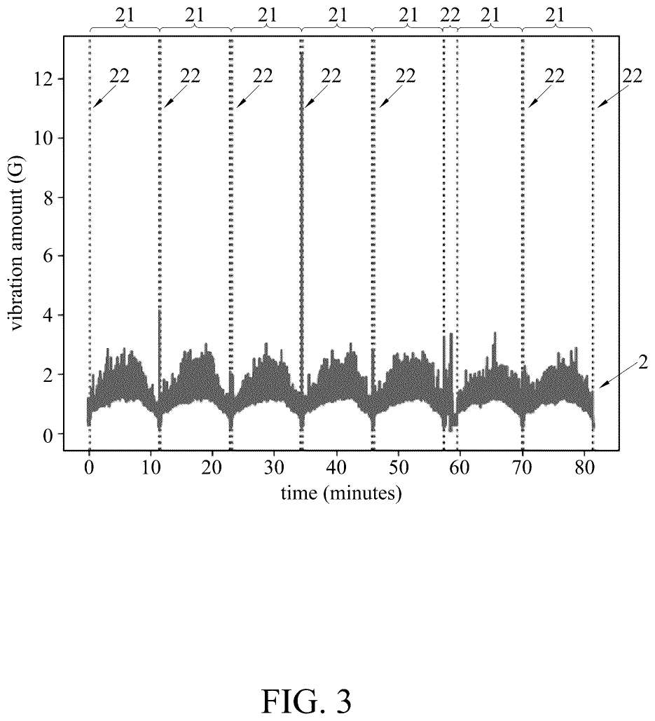

FIG. 3 is a schematic diagram of vibration data 2 of the accessory of the rotating machine obtained by the sensing module 11. In one embodiment, the sensing module 11 can connect each vibration data recorded for a fixed time length (e.g., five seconds) to each other to form a continuous and complete vibration data 2, as shown in FIG. 3, wherein the X-axis of FIG. 3 is time (minutes), and the Y-axis of FIG. 3 is vibration amount (G).

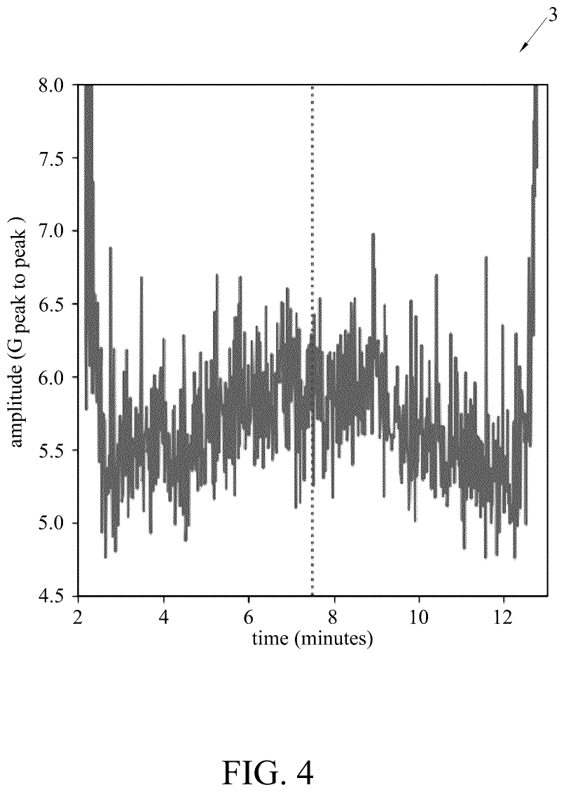

The data processing module 12 is used to process the vibration data 2 to generate a plurality of vibration timing data. In one embodiment, the data processing module 12 first calculates a standard deviation of the vibration data 2, defines a portion of the vibration data 2 that is greater than the standard deviation as an operation interval 21, and defines a portion of the vibration data 2 that is less than the standard deviation as a standby interval 22. In this way, an operation start point and an operation end point can be distinguished according to the operation interval 21 and the standby interval 22. For example, the standby interval 22 on the far left in FIG. 3 can be regarded as the operation start point, and the second standby interval 22 on the left in FIG. 3 can be regarded as the operation end point, and the vibration data of the operation interval 21 between the two standby intervals 22 can be used as the vibration timing data. That is, the vibration data 2 shown in FIG. 3 can generate seven vibration timing data (for example, it can represent that the electric saw equipment with a saw bed performs seven cutting operations using a saw belt), and when the X-axis unit of each vibration timing data is expressed in minutes and the Y-axis unit is converted from the vibration amount (G) to the amplitude (G)-peak to peak, it can be expressed as vibration timing data 3 shown in FIG. 4.

In one embodiment, all vibration data 2 within the operation interval 21 can be used as the vibration timing data 3, and the vibration data 2 within a certain time before and after the midpoint of the operation interval 21 (for example, five minutes before and after) can also be used as the vibration timing data 3, but the present disclosure is not limited to as such.

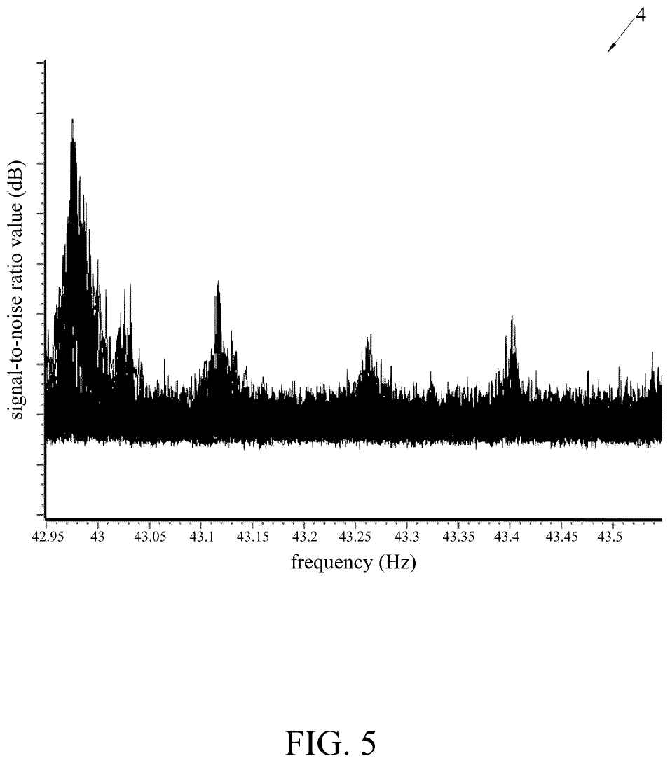

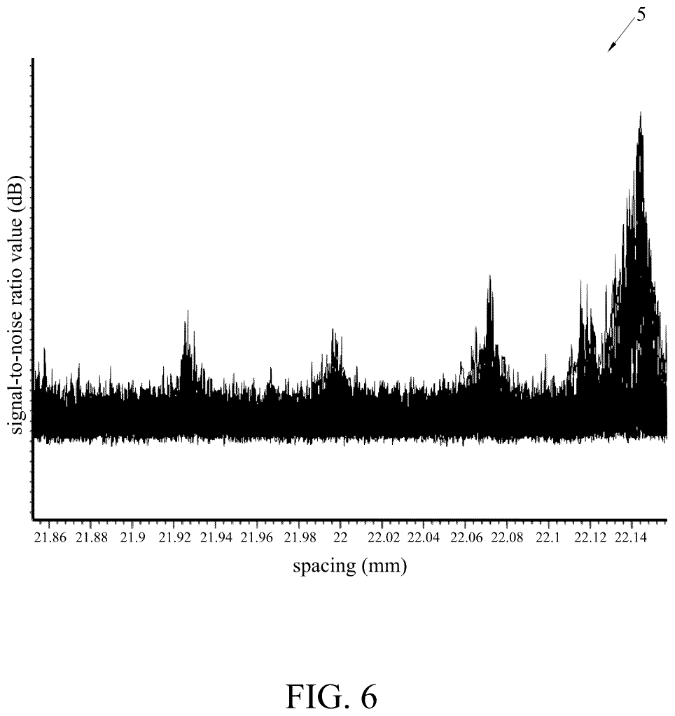

The conversion module 13 converts each of the plurality of vibration timing data 3 into a plurality of conversion data 5. In one embodiment, the conversion module 13 first converts each of the plurality of vibration timing data 3 into a plurality of intermediate data 4 (as shown in FIG. 5) using a first algorithm, and then converts the plurality of intermediate data 4 into a plurality of conversion data 5 (as shown in FIG. 6) using a second algorithm.

In one embodiment, the first algorithm is Fourier transform, fast Fourier transform, wavelet transform, or empirical mode decomposition. Taking fast Fourier transform as an example, the first algorithm can convert the vibration timing data 3 shown in FIG. 4 from the time domain to the frequency domain, that is, from time (minutes) to frequency (Hz). Then, the vibration amount (G) on the Y-axis of the vibration timing data 3 is divided by the standard deviation of the vibration data 2, and the vibration amount (G) on the Y-axis of the vibration timing data 3 can be converted into a signal-to-noise ratio value (dB). Afterwards, the intermediate data 4 is expressed in a manner in which the X-axis is the frequency (Hz) and the Y-axis is the signal-to-noise ratio value (dB), as shown in FIG. 5.

In one embodiment, the formula of the second algorithm is d=v/f, where d is the spacing (mm), v is the operating speed (m/min) of the rotating machine, and f is the frequency (Hz). Afterwards, the conversion data 5 is expressed in a manner in which the X-axis is the spacing (mm) and the Y-axis is the signal-to-noise ratio (dB), as shown in FIG. 6. The purpose of converting the vibration timing data 3 into the conversion data 5 with spacing (mm) as the X-axis is to make the comparison benchmarks of each of the plurality of vibration timing data 3 consistent. If only fast Fourier transformation is performed, only the intermediate data 4 represented in the form of frequency on the X-axis as shown in FIG. 5 will be obtained. When the frequency on the X-axis is inconsistent due to different operating speeds of the rotating machine, it may be impossible to compare. For example, in a case of comparing the same peaks in the vibration timing data 3, the peak may correspond to the position of 60 Hz when the operating speed is slow, and the peak may correspond to the position of 120 Hz when the operating speed is fast. In this way, there is no same benchmark and comparison is impossible. Therefore, after the vibration timing data 3 is converted into the conversion data 5 with the spacing (mm) as the X-axis by the second algorithm, when facing different operating speeds of the rotating machine, the obtained plurality of conversion data 5 still have the same spacing as a benchmark for comparison.

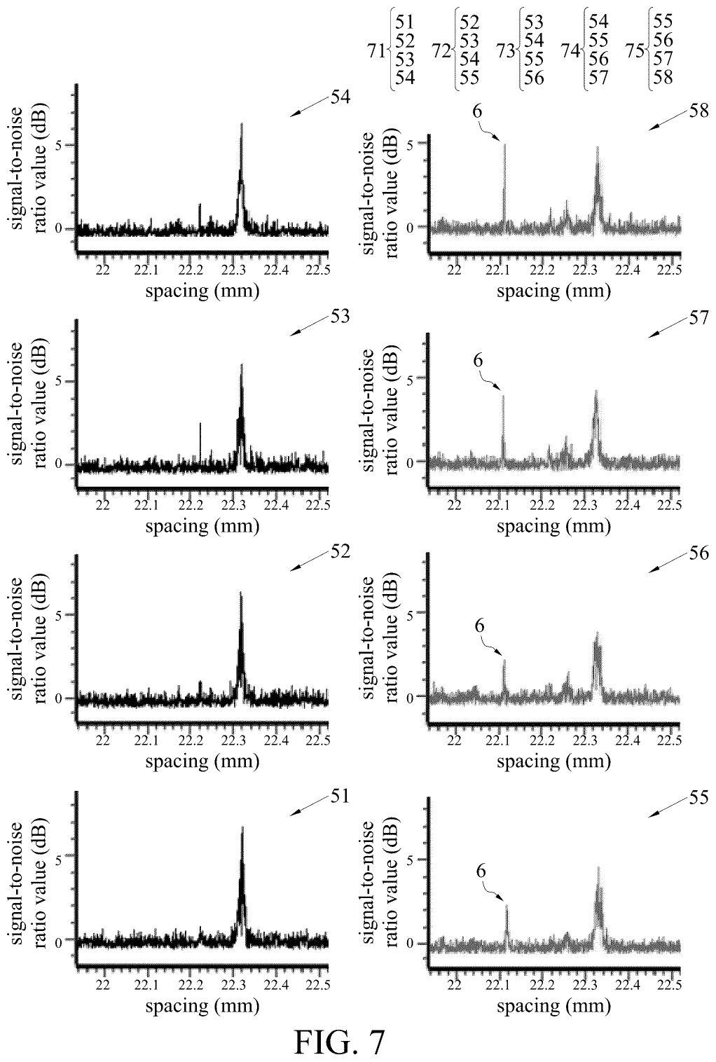

The abnormal feature detection module 14 compares the feature value distribution in the plurality of conversion data 51, 52, 53, 54, 55, 56, 57, 58, so as to define the accessory corresponding to the conversion data with a change in the feature value distribution as abnormal. Specifically, the plurality of conversion data 51, 52, 53, 54, 55, 56, 57, 58 can be presented in the manner of FIG. 7, so that the plurality of conversion data 51, 52, 53, 54, 55, 56, 57, 58 have the same X-axis, that is, have the same spacing interval. The abnormal feature detection module 14 first compares the feature value distribution of the conversion data 51 and the conversion data 52. The feature value distribution is specifically a signal-to-noise ratio distribution. The abnormal feature detection module 14 calculates the third quartile corresponding to the signal-to-noise ratio distribution of the same spacing interval of the conversion data 51 and the conversion data 52, and then compares whether there is a change between the third quartiles of the conversion data 51 and the conversion data 52. If the third quartiles of the conversion data 51 and the conversion data 52 should have similar or identical signal-to-noise ratio values, it is determined that there is no change (for example, it can represent that the saw belt in the electric saw equipment with a saw bed is not damaged). After comparing the conversion data 51 and the conversion data 52, if no change occurs, the next round of comparison can be performed, that is, comparing the conversion data 52 and the conversion data 53, and so on.

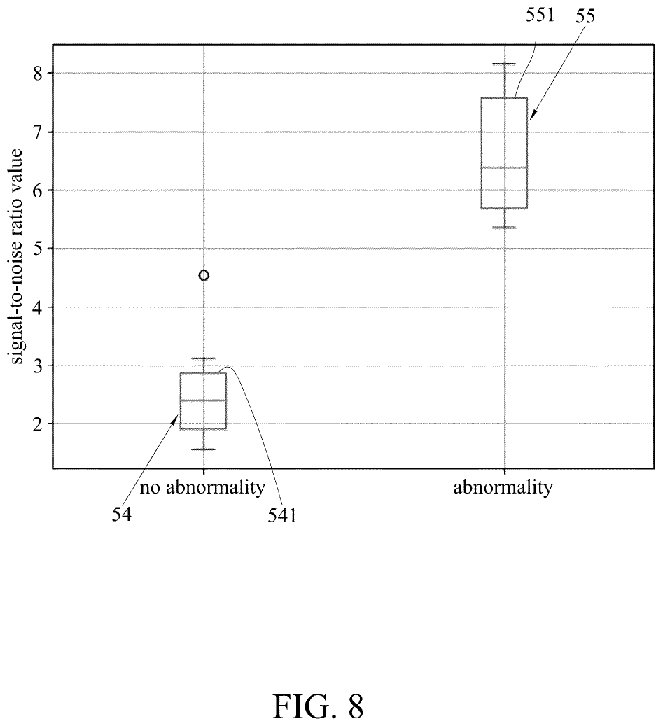

The situation in which a change is determined is as follows. For example, when comparing the conversion data 54 and the conversion data 55, as shown in FIG. 8, at the spacing of 22.1 mm to 22.2 mm, the third quartile 541 of the conversion data 54 and the third quartile 551 of the conversion data 55 have different signal-to-noise ratio values, which can be regarded as the conversion data 55 having a change 6 (FIG. 7), that is, the feature value distribution of the conversion data 55 has changed. At this time, the accessory corresponding to the conversion data 55 can be defined as abnormal (for example, it can represent that the saw belt in the electric saw equipment with a saw bed has damaged saw teeth). Subsequently, the abnormal position of the accessory can be inferred according to the spacing corresponding to the change 6 (such as 22.1 mm to 22.2 mm). For example, if the accessory is a saw belt, the position of the damaged saw teeth on the saw belt can be inferred.

In one embodiment, when the difference between the third quartiles is the greatest (that is, the difference has the maximum value), the accessory is defined as abnormal. In other embodiments, a range may be defined, and when the difference between the third quartiles falls within the range, the accessory is defined as abnormal, or a threshold value may be defined, and when the difference between the third quartiles exceeds the threshold value, the accessory is defined as abnormal. The present disclosure is not limited to as such.

In other embodiments, in addition to using the third quartile, the first quartile or median of the conversion data may be calculated to determine whether the feature value distribution has changed. The present disclosure is not limited to as such.

The above embodiment compares a single conversion data with the next single conversion data, but the present disclosure is not limited to as such. The feature value distribution of the plurality of conversion data 51, 52, 53, 54, 55, 56, 57, 58 can also be compared by integrating them in groups of N, where N is a natural number.

Specifically, the plurality of conversion data 51, 52, 53, 54, 55, 56, 57, 58 may be defined as a plurality of conversion data groups 71, 75, in a group of, for example, four. At this time, the conversion data groups 71, 75 are adjacent to each other, and the conversion data 51, 52, 53, 54 included in the conversion data group 71 and the conversion data 55, 56, 57, 58 included in the conversion data group 75 do not overlap with each other. The feature value distribution of the same spacing interval in the conversion data groups 71, 75 is calculated respectively, for example, the third quartile corresponding to the conversion data 51, 52, 53, 54 is calculated, and the third quartile corresponding to the conversion data 55, 56, 57, 58 is calculated. Since the conversion data 55, 56, 57, 58 all have a change 6, the feature value distribution of the conversion data group 75 changes compared to the feature value distribution of the conversion data group 71, and the difference has a maximum value. At this time, the accessory corresponding to the conversion data 55 in the conversion data group 75 can be defined as abnormal.

In one embodiment, the plurality of conversion data 51, 52, 53, 54, 55, 56, 57, 58 can also be defined in a group of four, for example, to define the plurality of conversion data groups 71, 72, 73, 74, 75, wherein the conversion data group 71 includes the conversion data 51, 52, 53, 54, the conversion data group 72 includes the conversion data 52, 53, 54, 55, the conversion data group 73 includes the conversion data 53, 54, 55, 56, the conversion data group 74 includes the conversion data 54, 55, 56, 57, and the conversion data group 75 includes the conversion data 55, 56, 57, 58. The plurality of conversion data 51, 52, 53, 54, 55, 56, 57, 58 between the plurality of conversion data groups 71, 72, 73, 74, 75 partially overlap each other. Since the conversion data 55 included in the conversion data group 72 has a change 6, the feature value distribution of the conversion data group 72 is changed compared to the conversion data group 71. In order to avoid misjudgments caused by noise, the feature value distributions of the conversion data group 73 and the conversion data group 71 can be compared. Since the conversion data 55, 56 included in the conversion data group 73 all have a change 6, the change amount of the feature value distribution of the conversion data group 73 compared to the conversion data group 71 is greater than the change amount of the feature value distribution of the conversion data group 72 compared to the conversion data group 71, that is, the third quartile of the conversion data group 73 is greater than the third quartile of the conversion data group 72. In a similar fashion, the feature value distributions of the conversion data group 74 and the conversion data group 71 and the feature value distributions of the conversion data group 75 and the conversion data group 71 are compared in sequence, it can be found that the third quartile of the conversion data group 75 is greater than the third quartile of the conversion data groups 71, 72, 73, 74 respectively. At this time, the accessory corresponding to the conversion data 55 in the conversion data group 75 can be defined as abnormal.

The above embodiment compares the conversion data groups 72, 73, 74, 75 with the conversion data group 71 respectively, but the present disclosure is not limited to as such. In other embodiments, the conversion data groups 71, 72, 73, 74, 75 can also be compared in an adjacent manner, and the accessory corresponding to the conversion data 55 in the conversion data group 75 with the greatest third quartile is defined as abnormal.

To sum up, in the rotating machine abnormal feature detection system and method of the present disclosure, since the conversion data uses the spacing as the X-axis instead of the frequency as the X-axis, the following scenarios can be used to effectively identify abnormalities in accessories: (1) different operating speeds of rotating machine; (2) in order to avoid resonance during operation, the spacing between the plurality of saw teeth on the saw belt is set into uneven distribution.

The foregoing embodiments are provided for the purpose of illustrating the principles and effects of the present disclosure, rather than limiting the present disclosure. Anyone skilled in the art can modify and alter the above embodiments without departing from the spirit and scope of the present disclosure. Therefore, the scope of protection with regard to the present disclosure should be as defined in the accompanying claims listed below.

What is claimed is:

1. A rotating machine abnormal feature detection system, comprising:
a sensing module configured for obtaining vibration data of an accessory of a rotating machine;
a data processing module configured for processing the vibration data to generate a plurality of vibration timing data;
a conversion module configured for converting each of the plurality of vibration timing data into a plurality of conversion data; and
an abnormal feature detection module configured for comparing a feature value distribution in the plurality of conversion data to define the accessory corresponding to the conversion data in which the feature value distribution changes as abnormal.

2. The rotating machine abnormal feature detection system of claim 1, wherein the abnormal feature detection module sequentially compares whether the feature value distribution of the same spacing interval in any two adjacent ones of the plurality of conversion data has changed, or first defines a plurality of conversion data groups by dividing the plurality of conversion data in groups of N, and then sequentially compares whether the feature value distribution of the same spacing interval in any two adjacent ones of the plurality of conversion data groups has changed, wherein N is a natural number.

3. The rotating machine abnormal feature detection system of claim 2, wherein the feature value distribution changes as a plurality of third quartiles corresponding to the same spacing interval in the plurality of conversion data or the plurality of conversion data groups are different from each other.

4. The rotating machine abnormal feature detection system of claim 2, wherein the plurality of conversion data between the plurality of conversion data groups partially overlaps with each other or do not overlap at all.

5. The rotating machine abnormal feature detection system of claim 3, wherein the abnormal feature detection module defines the accessory as abnormal when the plurality of third quartiles have the greatest difference between each other.

6. The rotating machine abnormal feature detection system of claim 5, wherein the feature value distribution is a signal-to-noise ratio value distribution, and the third quartile is calculated from a plurality of signal-to-noise ratio values in the spacing interval.

7. The rotating machine abnormal feature detection system of claim 1, wherein the data processing module first calculates a standard deviation of the vibration data, defines a portion of the vibration data that is greater than the standard deviation as an operation interval, and defines a portion of the vibration data that is less than the standard deviation as a standby interval, and wherein the vibration data corresponding to the operation interval between two adjacent standby intervals is the vibration timing data.

8. The rotating machine abnormal feature detection system of claim 7, wherein the conversion module first converts each of the plurality of vibration timing data into a plurality of intermediate data, and then converts the plurality of intermediate data into the plurality of conversion data.

9. The rotating machine abnormal feature detection system of claim 8, wherein the conversion module uses a first algorithm to convert each of the plurality of vibration timing data into the plurality of intermediate data, and an X-axis of the intermediate data is frequency, and a Y-axis is signal-to-noise ratio value, and wherein the signal-to-noise ratio value is a vibration amount of the vibration timing data divided by the standard deviation.

10. The rotating machine abnormal feature detection system of claim 9, wherein the first algorithm is Fourier transform, fast Fourier transform, wavelet transform, or empirical mode decomposition.

11. The rotating machine abnormal feature detection system of claim 8, wherein the conversion module uses a second algorithm to convert the plurality of intermediate data into the plurality of conversion data, and an X-axis of the conversion data is spacing and a Y-axis is signal-to-noise ratio value.

12. The rotating machine abnormal feature detection system of claim 11, wherein a formula of the second algorithm is d=v/f, wherein d is spacing, v is operating speed of the rotating machine, and f is frequency.

13. The rotating machine abnormal feature detection system of claim 1, wherein the vibration data is mechanical motion vibration data or sound vibration data.

14. A rotating machine abnormal feature detection method, comprising:
obtaining, via a sensing module, vibration data of an accessory of a rotating machine;
processing, via a data processing module, the vibration data to generate a plurality of vibration timing data;
converting, via a conversion module, each of the plurality of vibration timing data into a plurality of conversion data; and
comparing, via an abnormal feature detection module, a feature value distribution in the plurality of conversion data to define the accessory corresponding to the conversion data in which the feature value distribution changes as abnormal.

15. The rotating machine abnormal feature detection method of claim 14, wherein the abnormal feature detection module sequentially compares whether the feature value distribution of the same spacing interval in any two adjacent ones of the plurality of conversion data has changed, or first defines a plurality of conversion data groups by dividing the plurality of conversion data in groups of N, and then sequentially compares whether the feature value distribution of the same spacing interval in any two adjacent ones of the plurality of conversion data groups has changed, wherein N is a natural number.

16. The rotating machine abnormal feature detection method of claim 15, wherein the feature value distribution changes as a plurality of third quartiles corresponding to the same spacing interval in the plurality of conversion data or the plurality of conversion data groups are different from each other.

17. The rotating machine abnormal feature detection method of claim 15, wherein the plurality of conversion data between the plurality of conversion data groups partially overlaps with each other or do not overlap at all.

18. The rotating machine abnormal feature detection method of claim 16, wherein the abnormal feature detection module defines the accessory as abnormal when the plurality of third quartiles have the greatest difference between each other.

19. The rotating machine abnormal feature detection method of claim 18, wherein the feature value distribution is a signal-to-noise ratio value distribution, and the third quartile is calculated from a plurality of signal-to-noise ratio values in the spacing interval.

20. The rotating machine abnormal feature detection method of claim 14, wherein the data processing module first calculates a standard deviation of the vibration data, defines a portion of the vibration data that is greater than the standard deviation as an operation interval, and defines a portion of the vibration data that is less than the standard deviation as a standby interval, and wherein the vibration data corresponding to the operation interval between two adjacent standby intervals is the vibration timing data.

21. The rotating machine abnormal feature detection method of claim 20, wherein the conversion module first converts each of the plurality of vibration timing data into a plurality of intermediate data, and then converts the plurality of intermediate data into the plurality of conversion data.

22. The rotating machine abnormal feature detection method of claim 21, wherein the conversion module uses a first algorithm to convert each of the plurality of vibration timing data into the plurality of intermediate data, and an X-axis of the intermediate data is frequency, and a Y-axis is signal-to-noise ratio value, and wherein the signal-to-noise ratio value is a vibration amount of the vibration timing data divided by the standard deviation.

23. The rotating machine abnormal feature detection method of claim 22, wherein the first algorithm is Fourier transform, fast Fourier transform, wavelet transform, or empirical mode decomposition.

24. The rotating machine abnormal feature detection method of claim 21, wherein the conversion module uses a second algorithm to convert the plurality of intermediate data into the plurality of conversion data, and an X-axis of the conversion data is spacing and a Y-axis is signal-to-noise ratio value.

25. The rotating machine abnormal feature detection method of claim 24, wherein a formula of the second algorithm is d=v/f, wherein d is spacing, v is operating speed of the rotating machine, and f is frequency.

26. The rotating machine abnormal feature detection method of claim 14, wherein the vibration data is mechanical motion vibration data or sound vibration data.
